(19) United States
(12) Patent Application Publication
(10) Pub. No.: US 2026/0241406 A1
(43) Pub. Date: Aug. 20, 2026

(54) POWDER SEPARATOR SYSTEM FOR A POWDER COATING SYSTEM, POWDER COATING SYSTEM WITH SUCH A POWDER SEPARATOR SYSTEM, AND METHOD FOR OPERATING SUCH A POWDER COATING SYSTEM

(71) Applicant: GEMA SWITZERLAND GMBH, Gossau (CH)

(72) Inventors: Peter Steiger, Gossau (CH); Patrik Broger, St. Gallen (CH)

(21) Appl. No.: 19/164,164

(22) PCT Filed: Mar. 1, 2024
(86) PCT No.: PCT/EP2024/055365

§ 371 Date: Sep. 10, 2025

(30) Foreign Application Priority Data
Mar. 10, 2023 (DE) 10 2023 106 010.4

(51) Int. Cl. B05B 14/43; B05B 7/14; B05B 14/48

(52) U.S. Cl. CPC B05B 14/43; B05B 7/1454; B05B 14/48

(57) ABSTRACT

A powder separator system for a powder coating system can be operated selectively either in a single-color operating mode or in a multi-color operating mode. The powder separator system includes a first powder separator for the single-color operating mode and a second powder separator for the multi-color operating mode of the powder coating system The first powder separator has a first raw gas chamber with a first filter medium received therein and the second powder separator has a second raw gas chamber with a second filter medium received therein. A common clean gas chamber is assigned to the two powder separators, and is in fluid communication both with the first raw gas chamber and the second raw gas chamber. A common suction fan is assigned to the two powder separators in fluid communication with the common clean gas chamber via a clean gas channel.

### CROSS-REFERENCE TO RELATED APPLICATION(S)

This application is a U.S. National Stage Application of PCT International Application No. PCT/EP2024/055365, filed on Mar. 1, 2024, entitled “POWDER SEPARATOR SYSTEM FOR A POWDER COATING PLANT, POWDER COATING PLANT COMPRISING SUCH A POWDER SEPARATOR SYSTEM, AND METHOD OF OPERATING SUCH A POWDER COATING PLANT,” which claims priority to the German Patent Application No. 10 2023 106 010.4, filed on Mar. 10, 2023, entitled “POWDER SEPARATOR SYSTEM FOR A POWDER COATING PLANT, POWDER COATING PLANT COMPRISING SUCH A POWDER SEPARATOR SYSTEM, AND METHOD OF OPERATING SUCH A POWDER COATING PLANT,” which are incorporated herein by reference in their entireties.

### BACKGROUND

The present disclosure generally relates to the field of powder coating of workpieces. In particular, the present disclosure relates to a powder coating system that can be operated either in a single-color operating mode or in a multi-color operating mode.

In coating technology, it is generally known that in powder coating booths, in which workpieces or objects can be coated with powder by means of a spraying device, air and excess powder are extracted from the interior of the booth. For this purpose, it is customary to provide the powder coating booth with an extraction duct arrangement which, for example, has an extraction duct arranged in the booth substructure, the first end of which is fluidically connected to the interior of the booth via at least one extraction opening.

Such a powder coating booth is known, for example, from document EP 0 839 583 A2. This is a vertically cylindrical booth with a funnel-shaped booth floor comprising a suction connection for an external suction source in the center of the booth.

A similar cylindrical powder coating booth is also known from document DE 195 00 872 A1. In addition to the booth floor designed as an extraction funnel, this powder coating booth has a channel-like floor edge along the booth wall, through which air and powder particles can also be extracted from the booth separately from the extraction flow of the extraction funnel.

A vertically cylindrical powder coating booth with a flat base plate is known from document DE 198 37 877 A1. A slot extends diametrically through the base plate, into which powder particles lying on the booth floor can be pushed by a rotating cleaning device. Spray coating powder is usually pneumatically conveyed to spray devices, known as spray guns, and sprayed pneumatically and with electrostatic assistance onto the objects/workpieces to be coated. In powder coating booths, a slight negative pressure is usually maintained during spray coating operation to prevent powder particles from escaping from the powder coating booth. The negative pressure usually maintained in the powder coating booths during spray coating operation also serves to extract excess powder, i.e., powder particles that bounce off the object or workpiece or are sprayed past it.

In powder coating booths of this type, excess powder is extracted to prevent high powder concentrations in the interior of the booth, which could potentially lead to powder dust explosions. Furthermore, the extraction of excess powder serves to recover and recycle the powder.

To recover excess powder, i.e., powder that has been sprayed past the object/workpiece to be coated or has fallen off the object/workpiece, it is known to connect a powder separator, for example in the form of a centrifugal separator (cyclone), to the interior of the powder coating booth via an extraction opening. A suction fan, which is connected, for example, to an air outlet of the powder separator, extracts at least a large part of the excess powder and air from the interior of the powder coating booth through the powder separator. The extracted powder is separated from the suction air in the powder separator and transported to a powder container, from which it can be fed back together with fresh coating powder to a spraying device for spray coating objects in the powder coating booth. The air cleaned of the extracted excess powder in the powder separator passes through the suction fan either into the room atmosphere of the installation room of the powder coating booth or the powder separator or to a further filter system (post-filter), in which any powder particles still present in the air are separated.

In particular, it is known to use a cyclone or a cyclone system as a powder separator for separating powder from the extracted air. When using a cyclone system, which is set up, for example, from one or more cyclones, a suction fan extracts excess powder and air from the interior of the booth through the cyclone system, whereby the powder-air flow is separated into air and powder in the cyclone system by cyclone centrifugal forces. The separated powder falls into a collection container below the cyclone system, while the powder-free air is usually blown into the outside atmosphere via a post-filter. Cyclone systems usually require such a post-filter because they cannot separate fine powder particles from the air stream as completely as a filter system would. The powder separated by the cyclone system is usually also processed and reused for spray coating. In contrast, the powder separated by the post-filter is usually treated as waste.

Powder coating booths that are used for short coating times with a specific type of powder or for frequent changes of powder type are often cylindrical in design, as cylindrical powder coating booths can be cleaned more quickly than powder coating booths with a rectangular interior, thus enabling rapid color changes.

The term “color change” as used herein refers to the change from one type of powder to another, in particular to a different powder color. With a large color palette and short coating periods for the individual powder types, the downtimes for cleaning the powder coating booth and the powder separators used when changing from one powder type to another are often not insignificant, as a result, operating the powder coating booth becomes costly and inefficient, at least when no main color is used for more than 50% of the powder coating booth's operating time.

The powder coating system considered herein is, in particular, a powder coating system that can be operated either in a single-color operating mode or in a multi-color operating mode.

In a multi-color operating mode, different powder colors or powder types are sprayed for only a short time. In this multi-color operating mode of the powder coating system, a cyclone separator and a post-filter are usually used, and the waste powder from the post-filter is fed into a waste container. Although the powder separation efficiency of the cyclone separator is usually lower than that of the post-filter, it can be cleaned more quickly than the post-filter.

In a single-color operating mode, the same type of powder or the same powder color is used for a relatively long period of time. In the single-color operating mode of the powder coating system, it is therefore possible to dispense with the cyclone separator and feed the powder-air mixture containing the excess powder from the powder coating booth directly to a post-filter. The powder recovered in the post-filter can then be reused via a powder recovery line and a screening device, if necessary.

In single-color operating mode of the powder coating system, the cyclone separator is usually only used in combination with the post-filter if the coating powder is problematic. In this case, only the recovered powder from the cyclone separator is returned as recovery powder via a powder recovery line and, if necessary, a screening device, while the waste powder from the post-filter is discharged as waste into a waste container.

A problem to be solved by the present disclosure is to optimize and, in particular, simplify the cleaning of an air-powder mixture discharged from the coating booth for a powder coating system that can be operated either in a single-color operating mode or in a multi-color operating mode.

### SUMMARY

The present disclosure relates in particular to a powder separator system for a powder coating system that can be operated either in a single-color operating mode or in a multi-color operating mode.

The powder separator system has a first powder separator based on filtration technology for the single-color operating mode of the powder coating system and a second powder separator, also based on filtration technology, for the multi-color operating mode of the powder coating system.

A “powder separator based on filtration technology” is a powder separator designed to separate powder particles from a powder-air mixture by means of filtration using a filter medium. The powder-air mixture can flow through the filter medium, while the powder particles to be separated from the powder-air mixture to be filtered are retained by the filter medium. The permeation of air through the filter medium is associated with a pressure difference.

A surface filter is used as the filter medium in particular. In particular, it is preferred that the filter medium is designed as a plate and/or cartridge filter.

In the powder separator system according to the present disclosure, the first powder separator has a first raw gas chamber with a first filter medium received therein and the second powder separator has a second raw gas chamber with a second filter medium received therein. The first raw gas chamber of the first powder separator is preferably hermetically separated from the second raw gas chamber of the second powder separator.

The first raw gas chamber of the first powder separator has a first raw gas inlet through which a powder-air mixture extracted or discharged from a coating booth of the powder coating system can be fed as raw gas to the first raw gas chamber in the single-color operating mode of the powder coating system.

Similarly, the second raw gas chamber of the second powder separator has a second raw gas inlet through which a powder-air mixture extracted or discharged from the coating booth of the powder coating system, which may have previously passed through a centrifugal separator, can be fed as raw gas to the second raw gas chamber of the second powder separator in the multi-color operating mode of the powder coating system.

In other words, the powder separator system according to the present disclosure provides a first powder separator which is used in the single-color operating mode of the powder coating system to separate the powder particles from the powder-air mixture discharged from the coating booth in this operating mode.

When the powder coating system is operated in multi-color mode, however, the second powder separator is used to separate any residual powder that may still be present in the powder-air mixture that has been discharged from the coating booth and then passed through the centrifugal separator.

The powder separator system according to the present disclosure is characterized in particular by the fact that the two powder separators, i.e. the first powder separator for the single-color operating mode of the powder coating system and the second powder separator for the multi-color operating mode of the powder coating system, are assigned a common clean gas chamber which is in fluid communication with both the first raw gas chamber and the second raw gas chamber. Furthermore, the two powder separators are assigned a common suction fan, which is in fluid communication with the common clean gas chamber either directly or via a clean gas channel.

In other words, the powder separator system according to the present disclosure is a so-called combination filter, i.e., a single system which is designed for both the single-color and multi-color operating modes of the powder coating system.

Since this combination filter requires only a single suction fan to suck the powder-air stream to be cleaned through the first powder separator or the second powder separator as required, the powder separator system can be designed to be extremely compact and space-saving. Furthermore, there is no need to provide a separate suction fan with a corresponding control device for each powder separator, which means that the powder separator system can be designed more cost-effectively.

According to preferred embodiments of the powder separator system according to the present disclosure, the second raw gas inlet of the second powder separator is further designed, in particular in the single-color operating mode and preferably both in the single-color operating mode and in the multi-color operating mode of the powder coating system, to supply a powder-air mixture extracted or discharged from a powder supply chamber of the powder coating system to the second raw gas chamber of the second powder separator as raw gas.

Alternatively, however, it is also conceivable that the second raw gas chamber of the second powder separator has a third raw gas inlet via which a powder-air mixture extracted or discharged from a powder supply chamber of the powder coating system can be fed as raw gas to the second raw gas chamber of the second powder separator, in particular in the single-color operating mode and preferably both in the single-color operating mode and in the multi-color operating mode of the powder coating system.

With this further development of the powder separator system according to the present disclosure, the powder separator system thus has an additional function, namely to also clean the powder-air mixture extracted or discharged from the powder supply chamber of the powder coating system. A particular advantage of this is that the powder separator system does not require an additional powder separator for this purpose.

Alternatively or in addition to the aforementioned embodiment of the powder separator system according to the present disclosure, it is provided that the second raw gas inlet of the second powder separator is further designed, in particular in the multi-color operating mode of the powder coating system and preferably both in the multi-color operating mode and in the single-color operating mode of the powder coating system, to supply as raw gas a powder-air mixture extracted or discharged from a powder waste container chamber of the powder coating system to the second raw gas chamber of the second powder separator.

Alternatively, however, the second raw gas chamber may also have a fourth raw gas inlet, via which a powder-air mixture extracted or discharged from a powder waste container chamber of the powder coating system is supplied to the second raw gas chamber of the second powder separator, in particular in the multi-color operating mode of the powder coating system and preferably both in the multi-color operating mode of the powder coating system and in the single-color operating mode of the powder coating system.

In this embodiment of the powder separator system according to the present disclosure, the powder separator system also performs an additional task, namely cleaning the powder-air mixture extracted or discharged from the powder waste container chamber of the powder coating system, without the powder separator system requiring an additional powder separator for this purpose.

As an alternative to the two aforementioned embodiments of the powder separator system according to the present disclosure, in which the powder separator system also serves to clean a powder-air mixture extracted or discharged from a powder supply chamber of the powder coating system and/or for cleaning a powder-air mixture extracted or discharged from a powder waste container chamber of the powder coating system, it is conceivable that the second raw gas chamber has a third raw gas inlet via which the second raw gas chamber of the second powder separator is supplied with powder-air mixture extracted or discharged from a powder supply chamber of the powder coating system as raw gas, in particular in the single-color operating mode of the powder coating system and preferably both in the single-color operating mode and in the multi-color operating mode of the powder coating system, and via which the second raw gas chamber of the second powder separator, in particular in the multi-color operating mode of the powder coating system and preferably both in the multi-color operating mode of the powder coating system and in the single-color operating mode of the powder coating system, may be supplied with a powder-air mixture extracted or discharged from a powder waste container chamber of the powder coating system.

According to preferred embodiments of the powder separator system according to the present disclosure, it is provided that the first powder separator has a first powder collection area which is arranged and designed at least partially or in part below the first raw gas chamber of the first powder separator to receive at least part of the powder separated from the raw gas supplied to the first raw gas chamber by means of the first filter medium.

It is advantageous for the first powder collection area to have a first powder discharge outlet through which the powder collected in the first powder collection area can be fed, as required, preferably by means of a powder feed pump, to a powder supply chamber of the powder coating system.

This measure ensures that the coating powder recovered in the single-color operating mode of the powder coating system with the aid of the first powder separator can be fed back into the coating operation, i.e., can be “reused.”

With regard to the powder separated from the powder-air mixture supplied to the second powder separator by the second powder separator of the powder separator system, according to embodiments of the powder separator system according to the present disclosure, it is provided that the second powder separator has a second powder collection area, which is arranged and designed at least partially or in part below the second raw gas chamber of the second powder separator to collect at least part of the powder separated from the raw gas supplied to the second powder separator by means of the second filter medium.

The second powder collection area preferably has a (second) powder discharge outlet through which the powder collected in the second powder collection area can be fed as waste powder to a powder waste container chamber of the powder coating system, preferably by means of a powder conveying pump or by gravity, as required.

This ensures that the powder separated from the powder-air stream by means of the second powder separator in the multi-color operating mode of the powder coating system is not fed back to the powder supply or the powder supply chamber of the powder coating system. The same applies in a figurative sense to the powder which has been separated from the powder-air stream by means of the second powder separator when the powder-air stream has been extracted or discharged from the powder supply chamber of the powder coating system and/or from the powder waste container chamber of the powder coating system.

Problems to be solved by the present disclosure are also solved by a powder coating system for powder coating workpieces. The powder coating system can be operated either in a single-color operating mode or in a multi-color operating mode.

The powder coating system has at least one coating booth or powder coating booth in which the workpiece can be coated with powder. In addition, at least one extraction system is provided, via which, in particular during coating operation of the powder coating system or alternatively during cleaning operation of the powder coating system, a powder-air mixture can be discharged and, in particular, extracted from the at least one coating booth.

The powder coating system according to the present disclosure is characterized in particular in that it further comprises a powder separator system of the type mentioned above according to the present disclosure in order to clean the powder-air mixture discharged and, in particular, extracted from the at least one coating booth.

Preferably, the powder coating system according to the present disclosure further comprises a centrifugal separator which is designed to separate at least part of the powder contained in the powder-air mixture discharged and in particular extracted from the powder-air mixture from the at least one coating booth,.

In particular, it is provided in this context that the powder-air mixture discharged and, in particular, extracted from the at least one coating booth, is only fed to the centrifugal separator when the powder coating system is in its multi-color operating mode.

The term “centrifugal separator” as used herein generally refers to a mass force separator for separating powder particles contained in the powder-air mixture discharged and, in particular, extracted from the at least one coating booth. Centrifugal forces generated by creating a vortex flow are used as the separation method.

According to a preferred embodiment of the latter aspect, the centrifugal separator is preferably designed as a cyclone separator and, in particular, as a tangential cyclone separator. A tangential cyclone separator essentially consists of four parts: an inlet cylinder, a cone, a particle collection container, and an immersion tube mounted centrally from above in the inlet cylinder.

In the inlet cylinder, the powder-air mixture is blown or sucked in tangentially and brought onto a circular path. The taper of the subsequent cone increases the rotational speed of the powder-air mixture to such an extent that the powder particles are thrown against the cone walls by centrifugal force and slowed down to such an extent that they detach from the flow and trickle down into the collection container. The cleaned air leaves the cone upwards through the central immersion tube.

The guidance of the powder-air mixture can be reinforced by guide plates attached to the inner wall of the separator in a spiral shape.

The centrifugal separator used in the powder coating system according to the present disclosure thus has a corresponding inlet area for the powder-air mixture to be treated in the centrifugal separator, wherein the inlet area is preferably part of a tangential inlet cylinder.

The powder-air mixture discharged and, in particular, extracted from the at least one coating booth is fed to the cyclone separator via the inlet area. In addition, the centrifugal separator has an outlet area which is preferably part of the immersion tube mounted centrally from above in the inlet cylinder. The powder-air mixture pre-cleaned in the centrifugal separator is discharged via the outlet area.

In this context, it is preferably provided that the outlet area of the centrifugal separator is fluidically connected or connectable via a channel or pipe system to the second raw gas inlet, i.e. to the raw gas inlet of the second powder separator of the powder separator system. In this configuration, the second powder separator of the powder separator system thus serves as a post-filter for the centrifugal separator.

In order to ensure that the coating powder separated in the centrifugal separator from the correspondingly supplied powder-air mixture can be disposed of as required or returned to the powder supply of the powder coating system, it is provided according to embodiments of the powder coating system according to the present disclosure that the centrifugal separator is designed to have a powder outlet which can be connected as required via a powder line to the powder supply of the powder coating system or to a powder waste container of the powder coating system.

The powder outlet of the centrifugal separator is located in particular in the lower conical region of the cone of the separator. The powder collection container is sometimes also referred to as a “bunker.” The bunker can be emptied during operation of the centrifugal separator, whereby the powder is preferably discharged via a rotary valve to prevent gas exchange with the environment.

The rotary valve works on the basis of a rotor with a certain number of rotor blades, which rotates in a precisely fitting housing. Each rotor cell takes in powder as the material to be conveyed under the inlet opening, and the powder/material falls out at the outlet. This results in volumetrically continuous conveying. The conveying capacity is determined by the content of the rotor cells and the speed of the rotor.

In particular, in the latter design variants of the powder coating system according to the present disclosure, it is provided that the powder outlet of the centrifugal separator can also be connected, as required, either (via a powder line) to the powder waste container or (via a corresponding powder line) to a powder supply container of a powder supply system of the powder coating system.

In other words, the coating powder recovered in the centrifugal separator can either be disposed of (by feeding the coating powder to the powder waste container) or reused in the coating operation of the powder coating system by feeding the powder separated in the centrifugal separator via a powder line to a powder supply container of the powder supply of the powder coating system.

By connecting the extraction pipe system or extraction duct system either to the first raw gas inlet of the first powder separator of the powder separator system or to the inlet area of the centrifugal separator, it is possible in an easy-to-implement yet effective manner for the extraction pipe system or extraction duct system to be selectively fluidically connected to different powder separators, such as the centrifugal separator or the first powder separator designed as a filter separator.

In this way, the first powder separator of the powder separator system or the centrifugal separator with the second powder separator of the powder separator system which is connected downstream as a post-filter, can be selectively used either in single-color or multi-color coating mode of the powder coating system for powder separation. In particular, the first powder separator of the powder separator system can be used in coating operation with a first powder type and/or a first powder color during a single-color operating mode of the powder coating system, and the centrifugal separators can be used with the second powder separator of the powder separator system serving as a post-filter in coating operation with a different powder type and/or another powder color, in particular in the multi-color operating mode of the powder coating system, without it being necessary to replace the powder separators or to clean the powder separators intensively which would be disadvantageous in terms of rapid powder changeover with only short downtimes during powder changeover.

In this context, it is particularly conceivable that the extraction pipe system or extraction duct system has a corresponding distributor via which the extraction pipe system or extraction duct system is divided into two pipe system or duct system sections. A first duct system serves to feed the powder-air mixture to the first raw gas inlet of the first powder separator of the powder separator system, while the other duct section serves to feed the powder-air mixture to the centrifugal separator. The distributor is preferably arranged in the booth substructure of the at least one powder spray coating booth, so that a compact design of the powder coating booth and in particular of the powder coating system can be achieved, so that in particular the footprint of the powder coating booth is unchanged compared to conventional powder coating booths known from prior art.

In an easy-to-implement but nevertheless effective design of the latter aspect, the distributor, which is arranged in particular in the substructure of the powder coating booth, is designed as a T-or Y-piece with one inlet and two outlets. The inlet of the distributor is fluidically connected or connectable to the extraction duct, which serves to extract or discharge the powder-air mixture from the at least one coating booth as required. The two outlets of the distributor can each be fluidically connected or connectable to a duct section leading out of the booth substructure. One outlet of the distributor is fluidically connected to the first raw gas inlet of the first powder separator of the powder separator system, while the other outlet of the distributor is fluidically connected to the inlet area of the centrifugal separator.

In this way, it is possible to connect two independently operating powder separator systems to the extraction pipe system or extraction duct system, whereby-depending on the type of powder sprayed in the powder spray coating operation or depending on the respective operating mode of the powder coating system-one of the two powder separators (i.e., either the first powder separator of the powder separator system or the centrifugal separator with the second powder separator serving as a post-filter) is fluidically connected to the extraction pipe system or extraction duct system.

Alternatively, it is also conceivable to design the distributor, which is located, for example, in the booth substructure of the powder coating booth of the powder coating system, in a cross or star shape so that the distributor has a plurality (more than two) of outlets in addition to an inlet.

In particular, it is conceivable that a corresponding flow switchover device is provided in order to selectively form or separate a flow connection between the extraction pipe system or extraction duct system arranged in particular in the booth substructure of the at least one powder coating booth of the powder coating system and one of the at least two extraction pipe systems or extraction duct systems leading out of the booth substructure. In this context, it is conceivable, for example, that the flow switching device has at least one valve flap or at least one valve slide.

As already indicated, the powder coating system according to the present disclosure also comprises a powder supply with a powder supply chamber for supplying a powder spraying device (powder spray gun) with coating powder to be sprayed onto the workpiece to be coated as required.

According to a further aspect of the present disclosure, it is provided that the powder supply chamber is connected or connectable by means of an extraction pipe system or an extraction duct system to the second raw gas chamber of the second powder separator of the powder separator system in order to feed a powder-air mixture from the powder supply chamber to the second raw gas chamber of the second powder separator of the powder separator system. This measure ensures that the powder-air mixture to be discharged from the powder supply chamber of the powder coating system is properly cleaned by the powder separator system.

The powder separated from the powder-air mixture discharged from the powder waste container chamber in the second powder separator of the powder separator system is preferably treated as waste powder and fed to a powder waste container.

In this context in particular, it is advantageous for the powder coating system to also have a powder waste system with a powder waste container chamber for collecting waste powder, wherein the powder waste container chamber is preferably fluidically connected or connectable by means of an extraction pipe system or extraction channel system to the second raw gas chamber of the second powder separator of the powder separator system in order to feed a powder-air mixture from the powder waste container chamber of the powder waste system to the second raw gas chamber of the second powder separator of the powder separator system. The powder-air mixture fed in this way from the powder waste container chamber is cleaned in the second powder separator, i.e., the powder contained in the powder-air mixture fed in is separated from the air stream. The separated powder is preferably treated as waste powder and fed back to the powder waste container chamber.

In order to reuse the powder separated by the first powder separator of the powder separator system, particularly in the single-color operating mode of the powder coating system, it is particularly provided that that the first powder separator of the powder separator system has a first powder collection area, which is preferably arranged and designed at least partially or in part below the first raw gas chamber of the first powder separator to collect at least part of the powder separated from the raw gas supplied to the first powder separator by means of the first filter medium.

Preferably, the first powder collection area has a first powder discharge outlet through which the powder collected in the first powder collection area can be fed, as required, preferably by means of a powder feed pump, to a powder supply chamber of the powder coating system. In this way, the powder separated by means of the first powder separator, particularly in the single-color operating mode of the powder coating system, can be fed back into the powder coating process and thus reused.

The present disclosure also relates to a method for operating a powder coating system. The powder coating system is preferably a powder coating system according to the present disclosure of the type described above.

In the method according to the present disclosure, a powder separator system of the type described above according to the present disclosure is provided. It is provided that, in the single-color operating mode of the powder coating system, only the first raw gas chamber of the first powder separator is supplied with a powder-air mixture extracted or discharged from a coating booth of the powder coating system as raw gas. It is also provided that, in the multi-color operating mode of the powder coating system, only the second raw gas chamber of the second powder separator is supplied with a powder-air mixture extracted or discharged from a coating booth of the powder coating system as raw gas, which may have previously passed through a centrifugal separator.

It is also advantageously provided that, in particular in the single-color operating mode of the powder coating system and preferably both in the single-color operating mode and in the multi-color operating mode of the powder coating system, only the second raw gas chamber of the second powder separator is further supplied with a powder-air mixture extracted or discharged from a powder supply chamber of the powder coating system as raw gas.

Alternatively or in addition to this, it is provided that, in particular in the single-color operating mode of the powder coating system and preferably both in the single-color operating mode and preferably both in the single-color operating mode and in the multi-color operating mode of the powder coating system, only the second raw gas chamber of the second powder separator is further supplied with a powder-air mixture extracted or discharged from a powder waste container chamber of the powder coating system as raw gas.

### BRIEF DESCRIPTION OF THE DRAWINGS

Below, with reference to the accompanying drawings, an exemplary embodiment of the present disclosure is described in more detail.

In the drawings:

FIG. 1 schematically shows an exemplary embodiment of the powder coating system according to the present disclosure, wherein the powder coating system is operated in a single-color operating mode;

FIG. 2 schematically shows the exemplary embodiment of the powder coating system according to the present disclosure as shown in FIG. 1, wherein, however, the powder coating system is operated in a multi-color operating mode;

FIG. 3 shows schematically and in an isometric view a further exemplary embodiment of the coating system according to the present disclosure;

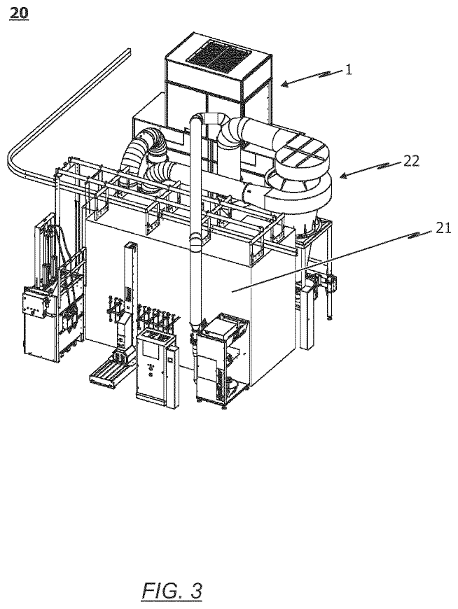

FIG. 4 shows schematically and in a further isometric view, the exemplary embodiment of the powder coating system according to the present disclosure as shown in FIG. 3;

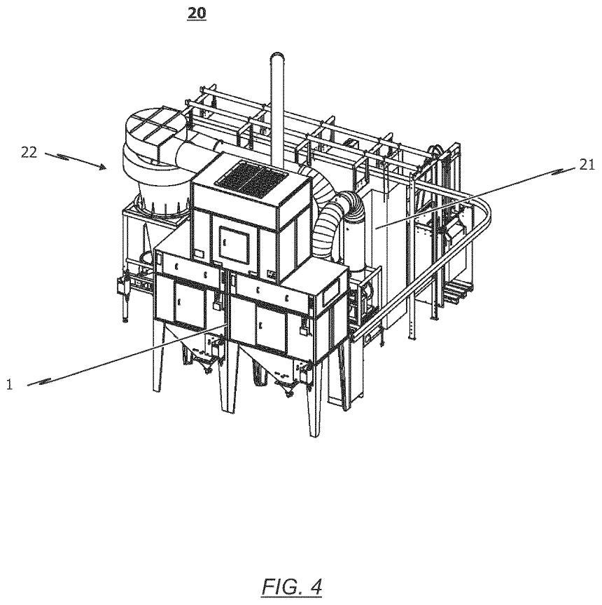

FIG. 5 shows schematically and in a (first) isometric view, the powder separator system of the powder coating system according to FIG. 3; and

FIG. 6 shows schematically and in a (second) isometric view, the powder separator system according to FIG. 5.

### DETAILED DESCRIPTION

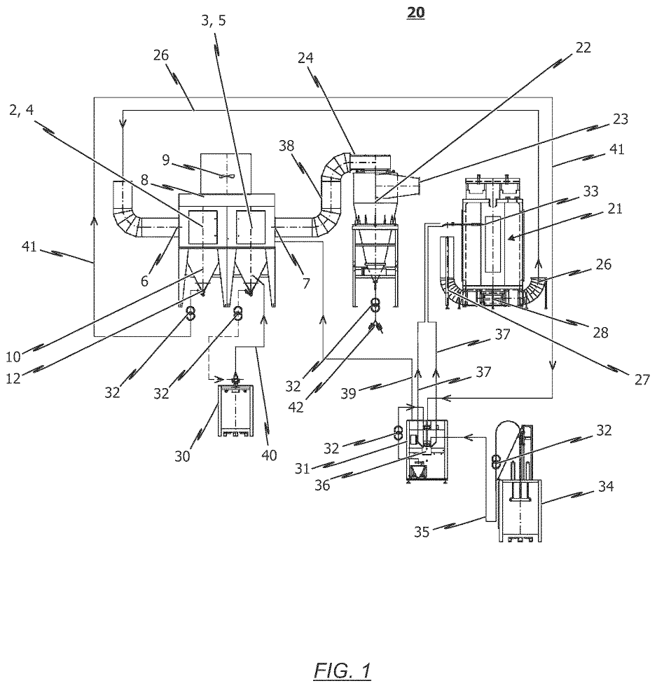

FIG. 1 schematically shows an embodiment of a powder coating system 20 according to the present disclosure for spray coating workpieces or objects with coating powder, which is then melted onto the object or workpiece in a heating furnace (not shown). A control device is provided to control the functions of the powder coating system 20. Powder pumps are provided for pneumatically conveying the coating powder from a powder supply chamber 31 to spray guns 33. These can be injectors in which coating powder is sucked from a powder container 36 inside the powder supply chamber 31 by means of compressed air serving as conveying air, after which the mixture of conveying air and coating powder flows together to the spray gun 33.

Pump types that convey small powder portions one after the other by means of compressed air can also be used as powder pumps, whereby a small powder portion (powder quantity) is stored in a powder chamber and then pressed out of the powder chamber by means of compressed air. The compressed air remains behind the powder portion and pushes the powder portion forward. These types of pumps are also referred to as “compressed air push pumps” or “drop feed pumps.”

Fresh powder from a powder supplier is fed from a fresh powder system 34, which is, for example, a small container, for example in the form of a dimensionally stable container or a bag with a powder quantity of, for example, between 10 and 50 kg, or, for example, a large container, for example also a dimensionally stable container or a bag with a powder quantity between 100 kg and 1,000 kg, by means of a powder pump 32 in a fresh powder line 35 of a screening device. The coating powder screened by the screening device is conveyed by gravity or preferably by a powder pump 32 via at least one powder feed line into an intermediate container chamber of an intermediate container 36, which is in particular dimensionally stable. The volume of the intermediate container chamber is preferably smaller and, in particular, significantly smaller than the volume of the small fresh powder container.

The intermediate container 36 for temporarily storing the coating powder has at least one powder pump 32, for example in the form of a dilute phase powder pump (injector) or in the form of a dense phase powder pump, in order to convey coating powder through corresponding powder lines 37 to spray devices 33. The spray devices 33 can have spray nozzles or rotary atomizers for spraying the coating powder onto the workpiece to be coated, which is preferably located in a powder coating booth 21.

Coating powder that does not adhere to the workpiece is removed from the coating booth 21 as excess powder.

The coating booth 21 is equipped with an extraction system, via which a powder-air mixture can be discharged and, in particular, extracted from the coating booth 21, especially during coating or cleaning operations of the powder coating system 20.

The extraction system has a first extraction pipe system or extraction duct system 26 and a second extraction pipe system or extraction duct system 27. Via a corresponding distributor/switch 28, either the first extraction pipe system or extraction duct system 26 or the second extraction pipe system or extraction duct system 27 is in fluid communication with the interior of the booth, so that the powder-air mixture can be discharged or extracted from the coating booth 21 either via the first extraction pipe system or extraction duct system 26 or the second extraction pipe system or extraction duct system 27.

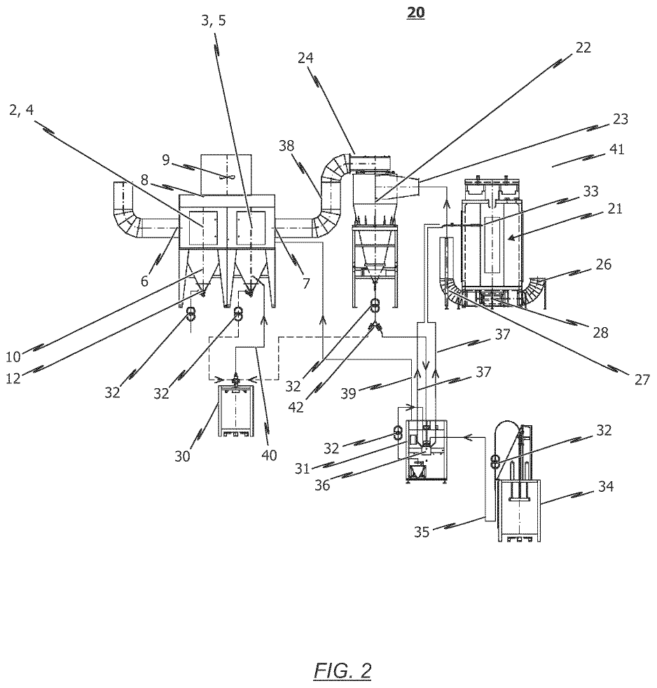

In the embodiment of the powder coating system 20 shown in FIG. 1 and FIG. 2, the first extraction pipe system or extraction duct system 26 is provided to be in fluid communication with a first raw gas inlet 6 of a first powder separator 2 of a powder separator system 1.

The second extraction pipe system or extraction duct system 27, on the other hand, is in fluid communication with an inlet area 23 of a centrifugal separator 22 designed as a cyclone separator. In the centrifugal separator 22, the powder-air mixture supplied via the second extraction pipe system or extraction duct system 27 and the inlet area 23 of the centrifugal separator 22 is pre-cleaned.

In other words, at least part of the powder contained in the powder-air mixture is separated in the centrifugal separator 22. The powder-air mixture pre-cleaned in this way is fed from the outlet area 24 of the centrifugal separator 22 via a corresponding channel system 38 to a second raw gas inlet 7 of a second powder separator 3 of the powder separator system 1.

In a single-color operating mode, as indicated in FIG. 1, a fluid communication between the interior of the booth and the second extraction pipe system or extraction duct system 27 is interrupted. In other words, in the single-color operating mode, the powder-air mixture discharged and, in particular, extracted from the coating booth 21 is fed exclusively via the first extraction pipe system or extraction duct system 26 to the first powder separator 2 of the powder separator system 1.

In a multi-color operating mode, on the other hand, the fluid communication between the interior of the booth and the first extraction pipe system or extraction duct system 26 is interrupted. Rather, in this operating mode—as shown in FIG. 2—there is a fluid communication between the second extraction pipe system or extraction duct system 27 and the interior of the booth. Thus, in the multi-color operating mode, the powder-air mixture discharged and extracted from the coating booth 21 is first fed exclusively to the centrifugal separator 22 and then to the second powder separator 3, which serves as a post-filter.

Regardless of whether the powder coating system 20 is operated in single-color or multi-color operating mode, it is provided that a powder supply chamber 31 of the powder supply of the powder coating system 20 is fluidically connected to the second powder separator 3 via an extraction pipe system or extraction duct system 39 in order to feed a powder-air mixture from the powder supply chamber 31 to the second powder separator 3. The powder separated from the powder-air mixture in the second powder separator 3 then enters a powder waste container 30.

The powder waste container 30 can either be arranged directly below the powder separator 3, especially if smaller quantities of powder waste are expected, or—as shown in FIG. 2—be integrated into a waste station.

The powder waste container 30 is accommodated in a powder waste container chamber, for example as a bag. The powder waste container chamber 30 is also fluidically connected to the second powder separator 3 via an extraction pipe system or extraction duct system 40 in order to feed a powder-air mixture from the powder waste container chamber 30 to the second powder separator 3 of the powder separator system 1. The powder separated from this powder-air mixture into the second powder separator 3 then returns to the powder waste container 30.

The supply of a powder-air mixture from the powder waste container chamber 30 to the second powder separator 3 and the supply of a powder-air mixture from the powder supply chamber 31 to the second powder separator 3 takes place both in single-color operating mode and in multi-color operating mode of the powder coating system 20.

The powder-air mixture discharged from the coating booth 21 in single-color operating mode is cleaned in the first powder separator 2. The cleaned air is discharged as clean gas into the installation room of the powder separator system 1. The powder separated from the powder-air mixture is fed back to the powder supply chamber 31 of the powder coating system 20 by means of a powder pump 32 and a powder line 41.

The powder-air mixture fed to the centrifugal separator 22 in the multi-color operating mode of the powder coating system 20 is pre-cleaned in the centrifugal separator 22. The powder produced during this process and separated from the powder-air mixture is fed either to the powder waste system 30 or to the powder supply chamber 31. A corresponding powder pump 32 and a valve arrangement 42 are used for this purpose.

The powder-air mixture pre-cleaned in the centrifugal separator 22 is then fed to the second powder separator 3, which serves as a post-filter. The powder separated from this powder-air mixture is treated as waste and fed to the powder waste container chamber 30.

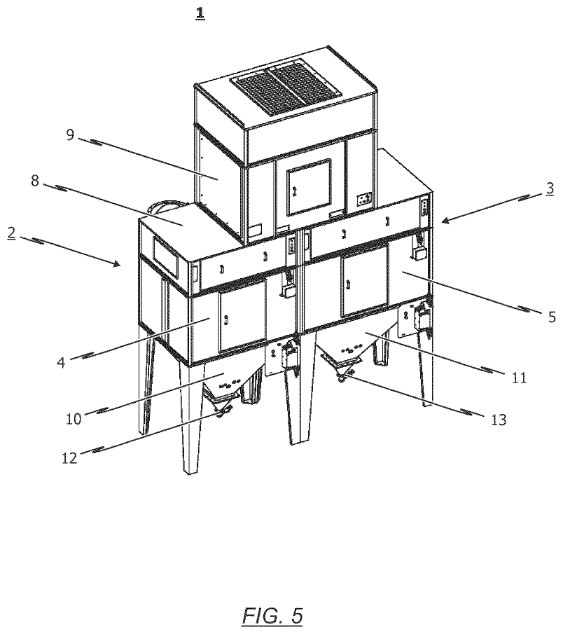

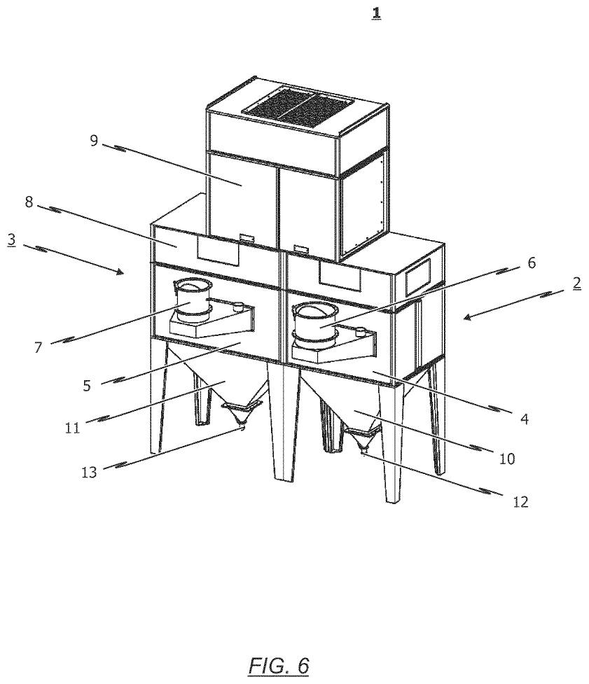

As can be seen in particular from the illustrations in FIG. 5 and FIG. 6, the powder separator system 1 used in the powder coating system 20 has a first powder separator 2 based on filtration technology for the single-color operating mode of the powder coating system 20 and a second powder separator 3, also based on filtration technology, for the multi-color operating mode of the powder coating system 20.

The first powder separator 2 has a first raw gas chamber 4 with a first filter medium (not shown in the drawings) accommodated therein. Similarly, the second powder separator 3 has a second raw gas chamber 5 with a second filter medium (also not shown in the drawings) accommodated therein.

The first and/or second filter medium can be designed as a plate and/or cartridge filter.

The first raw gas chamber 4 has a first raw gas inlet 6 through which the powder-air mixture extracted or discharged from the coating booth 21 of the powder coating system 20 is fed as raw gas to the first raw gas chamber 4 in the single-color operating mode of the powder coating system 20.

The second powder separator 3 of the powder separator system 1 has a second raw gas inlet 7, through which the powder-air mixture extracted or discharged from the coating booth 21 of the powder coating system 20 is fed as raw gas to the second raw gas chamber 5 of the second powder separator 3 in the multi-color operating mode of the powder coating system 20, which mixture has previously passed through the centrifugal separator 22.

In the embodiment shown in the drawings, it is provided that via the second raw gas inlet 7 of the second powder separator 3 both in the single-color operating mode and in the multi-color operating mode of the powder coating system 20 additionally a power-air-mixture extracted or discharged of the powder supply chamber 31 of the powder coating system 20 is supplied as raw gas to the second raw gas chamber 5 of the second powder separator 3.

Of course, it is also conceivable here that an additional raw gas inlet is provided for feeding the powder-air mixture extracted or discharged from the powder supply chamber 31 of the powder coating system 20.

In the embodiment shown in the drawings, it is further provided that a powder-air mixture extracted or discharged from the powder waste container chamber 30 of the powder coating system 20 is also fed as raw gas via the second raw gas inlet 7 of the second powder separator 3 to the second raw gas chamber 5.

Here too, it is conceivable in principle to provide an additional (dedicated) raw gas inlet.

Preferably, the powder-air mixture extracted or discharged from the powder supply chamber 31 of the powder coating system 20 and the powder-air mixture extracted or discharged from the powder waste container chamber 30 of the powder coating system 20 is supplied as raw gas to the second powder separator 3 and, in particular, to the second raw gas chamber of the second powder separator 3, both in single-color and in multi-color operating mode.

The powder separator system 1, as shown in particular in FIG. 5 and FIG. 6 by means of an embodiment, is characterized in particular in that the two powder separators (i.e. the first powder separator 2 and the second powder separator 3) is assigned a common clean gas chamber 8, which is in fluid communication with both the first raw gas chamber 4 of the first powder separator 2 and the second raw gas chamber 5 of the second powder separator 3.

In addition, the two powder separators 2, 3 of the powder separator system 1 are assigned a common suction fan 9, which is preferably in fluid communication with the common clean gas chamber 8 via a clean gas channel or directly.

The first powder separator 2 of the powder separator system 1 has a first powder collection area 10, which is arranged and designed at least partially or in part below the first raw gas chamber 4 to collect at least part of the powder separated from the raw gas supplied to the first raw gas chamber 4 by means of the first filter medium.

The first powder collection area 10 has a first powder discharge outlet 12 through which the powder collected in the first powder collection area 10 can be fed back to the powder supply chamber 31 of the powder coating system 20 as required, preferably by means of a powder feed pump 32.

The second powder separator 3 of the powder separator system 1 also has a second powder collection area 11, which is arranged and designed at least partially or in part below the second raw gas chamber 5 to collect at least part of the powder separated from the raw gas supplied to the second raw gas chamber 5 by means of the second filter medium.

The second powder collection area 11 has a second powder discharge outlet 13, via which the powder collected in the second powder collection area 11 can be fed, as required, preferably by means of a powder feed pump 32, either to the powder waste container chamber 30 of the powder coating system 20 or to the powder supply chamber 31 of the powder coating system 20.

The powder separator system 1 has a single control device via which the common suction fan 9 can be controlled.

The present disclosure is not limited to the embodiment shown in the drawings, but results from a combination of all the features disclosed herein.

### List of Reference Signs

1 Powder separator system
2 First powder separator
3 Second powder separator
4 First raw gas chamber
5 Second raw gas chamber
6 First raw gas inlet
7 Second raw gas inlet
8 Clean gas chamber
9 Suction fan
10 First powder collection area
11 Second powder collection area
12 First powder discharge outlet
13 Second powder discharge outlet
20 Powder coating system
21 Coating booth
22 Centrifugal separator
23 Inlet area of the centrifugal separator
24 Outlet area of the centrifugal separator
25 Duct or pipe system between the centrifugal separator and the second powder separator
26 First extraction pipe system or extraction duct system
27 Second extraction pipe system or extraction duct system
28 Distributor/switch
29 Powder outlet of the centrifugal separator
30 Powder waste container chamber/powder waste container
31 Powder supply container/powder supply
32 Powder pump
33 Spray gun/spray device
34 Fresh powder system
35 Fresh powder line
36 Intermediate container
37 Powder line
38 Channel system
39 Extraction pipe system/extraction duct system
40 Extraction pipe system/extraction duct system
41 Powder line
42 Valve arrangement

1. A powder separator system for a powder coating system (20) that can be operated either in a single-color operating mode or in a multi-color operating mode, the powder separator system comprising:
a first powder separator based on filtration technology for the single-color operating mode of the powder coating system; and
a second powder separator based on filtration technology for the multi-color operating mode of the powder coating system,
wherein:
the first powder separator has a first raw gas chamber with a first filter medium received therein and the second powder separator has a second raw gas chamber with a second filter medium received therein,
the first raw gas chamber has a first raw gas inlet through which a powder-air mixture extracted or discharged from a coating booth of the powder coating system can be fed as raw gas to the first raw gas chamber in the single-color operating mode of the powder coating system,
the second raw gas chamber has a second raw gas inlet through which a powder-air mixture extracted or discharged from a coating booth of the powder coating system can be fed as raw gas to the second raw gas chamber in the multi-color operating mode of the powder coating system, which powder-air mixture may have previously passed through a centrifugal separator,
a common clean gas chamber is assigned to the two powder separators, and is in fluid communication both with the first raw gas chamber and the second raw gas chamber, and
a common suction fan is assigned to the two powder separators, and is in fluid communication with the common clean gas chamber via a clean gas channel.

2. The powder separator system according to claim 1, wherein:
the second raw gas inlet of the second powder separator is further designed, both in the single-color operating mode and in the multi-color operating mode of the powder coating system, to supply a powder-air mixture extracted or discharged from a powder supply chamber of the powder coating system to the second raw gas chamber as raw gas; or
the second raw gas chamber of the second powder separator has a third raw gas inlet via which, both in the single-color operating mode and in the multi-color operating mode of the powder coating system, a powder-air mixture extracted or discharged from the powder supply chamber of the powder coating system is supplied to the second raw gas chamber as raw gas.

3. The powder separator system according to claim 1, wherein:
the second raw gas inlet of the second powder separator is further designed, both in the single-color operating mode and in the multi-color operating mode of the powder coating system, to supply a powder-air mixture extracted or discharged from a powder waste container chamber of the powder coating system to the second raw gas chamber as raw gas; or
the second raw gas chamber of the second powder separator has a fourth raw gas inlet via which a powder-air mixture extracted or discharged from a powder waste container chamber of the powder coating system is supplied to the second raw gas chamber, both in the single-color operating mode and in the multi-color operating mode of the powder coating system.

4. The powder separator system according to claim 1,
wherein the second raw gas chamber has a third raw gas inlet via which the second raw gas chamber can be supplied with a powder-air mixture extracted or discharged from the powder supply chamber of the powder coating system both in the single-color operating mode and in the multi-color operating mode of the powder coating system as raw gas, and via which the second raw gas chamber, both in the single-color operating mode and in the multi-color operating mode of the powder coating system can be supplied with a powder-air mixture extracted or discharged from a powder waste container chamber of the powder coating system.

5. The powder separator system according to claim 1,
wherein the first powder separator has a first powder collection area which is arranged and designed at last partially below the first raw gas chamber to collect at least part of the powder separated from the raw gas supplied to the first raw gas chamber by means of the first filter medium, wherein the first powder collection area has a first powder discharge outlet through which the powder collected in the first powder collection area can be fed, by means of a powder conveying pump, to a powder supply chamber of the powder coating system.

6. The powder separator system according to claim 1,
wherein the second powder separator has a second powder collection area which is arranged and designed at least partially below the second raw gas chamber to collect at least part of the powder separated from the raw gas supplied to the second raw gas chamber by means of the second filter medium, wherein the second powder collection area has a second powder discharge outlet through which the powder collected in the second powder collection area can be discharged by means of a powder conveying pump, selectively to a powder waste container chamber of the powder coating system or to a powder supply chamber of the powder coating system or to a powder waste container chamber of the second powder separator.

7. The powder separator system according to claim 1, wherein:
the first filter medium is designed as a plate and/or cartridge filter; and/or
the second filter medium is designed as a plate and/or cartridge filter.

8. The powder coating system for powder coating workpieces, wherein the powder coating system can be operated either in a single-color operating mode or in a multi-color operating mode, comprising:
at least one coating booth in which the workpiece can be coated with powder;
at least one extraction system, via which, during coating or cleaning operation of the powder coating system, a powder-air mixture can be discharged and extracted from the at least one coating booth; and
a powder separator system according to claim 1 for cleaning the powder-air mixture discharged and extracted from the at least one coating booth.

9. The powder coating system according to claim 8,
wherein the powder coating system further comprises a centrifugal separator which is designed to separate at least part of the powder contained in the powder-air mixture discharged and in extracted from the powder-air mixture from the at least one coating booth.

10. The powder coating system according to claim 9,
wherein the centrifugal separator is designed as a tangential cyclone separator and has an inlet area for supplying the powder-air mixture discharged and extracted from the at least one coating booth, and an outlet area for discharging the powder-air mixture pre-cleaned in the centrifugal separator.

11. The powder coating system according to claim 10,
wherein the outlet area of the centrifugal separator is fluidically connected or connectable to the second raw gas inlet of the powder separator system via a channel or duct system.

12. The powder coating system according to claim 10,
wherein the at least one coating booth is assigned an extraction pipe system or extraction duct system for discharging the powder-air mixture from the at least one coating booth, wherein the extraction pipe system or extraction duct system can be fluidically connected either to the first raw gas inlet of the powder separator system or to the inlet area of the centrifugal separator.

13. The powder coating system according to claim 9, wherein:
the centrifugal separator has a powder outlet which can be connected as required via a powder line to a powder waste container of the powder coating system; and/or
the centrifugal separator has a powder outlet which can be connected via a powder line to a powder supply container of a powder supply system of the powder coating system.

14. The powder coating system according to claim 8,
wherein the powder coating system further comprises a powder supply with a powder supply chamber for supplying a powder spraying device with coating powder to be sprayed onto the workpiece to be coated, wherein the powder supply chamber is connected or connectable by means of an extraction pipe system or extraction duct system to the second raw gas chamber of the powder separator system for supplying a powder-air mixture from the powder supply chamber to the second raw gas chamber of the powder separator system.

15. The powder coating system according to claim 8,
wherein the powder coating system further comprises a powder waste system with a powder waste container chamber for receiving waste powder, wherein the powder waste container chamber is fluidically connected or connectable via an extraction pipe system or extraction duct system to the second raw gas chamber of the powder separator system for supplying a powder-air mixture from the powder waste container chamber to the second raw gas chamber of the powder separator system.

16. The powder coating system according to claim 8,
wherein the first powder separator of the powder separator system has a first powder collection area which is arranged and designed at least partially below the first raw gas chamber to receive at least part of the powder separated from the raw gas supplied from the first raw gas chamber by means of the first filter medium, wherein the first powder collection area has a first powder discharge outlet via which the powder collected in the first powder collection area can be fed by means of a powder feed pump, to a powder supply chamber of the powder coating system.

17. A method for operating a powder coating system according to claim 8, the method comprising the following method steps:
supplying, in the single-color operating mode of the powder coating system, only the first raw gas chamber of the first powder separator with a powder-air mixture extracted or discharged from a coating booth of the powder coating system as raw gas, and
supplying, in the multi-color operating mode of the powder coating system, only the second raw gas chamber of the second powder separator with a powder-air mixture extracted or discharged from a coating booth of the powder coating system which may have previously passed through a centrifugal separator (22) as raw gas.

18. The method according to claim 17,
wherein, both in the single-color operating mode and in the multi-color operating mode of the powder coating system, only the second raw gas chamber of the second powder separator is further supplied with a powder-air mixture extracted or discharged from a powder supply chamber of the powder coating system as raw gas.

19. The method according to claim 17,
wherein, both in the single-color operating mode and in the multi-color operating mode of the powder coating system, only the second raw gas chamber of the second powder separator is further supplied with a powder-air mixture is extracted or discharged from a powder waste container chamber of the powder coating system as raw gas.
